(19) United States
(12) Patent Application Publication
(10) Pub. No.: US 2009/0308955 A1
(43) Pub. Date: Dec. 17, 2009

(54) WATER SAVING SHOWER NOZZLE

(76) Inventor: Huasong ZHOU, Xiamen (CN)

Correspondence Address: Dr. BANGER SHIA, 102 Lindencrest Ct., Sugar Land, TX, 77479-5201, US

(21) Appl. No.: 12/138,699

(22) Filed: Jun. 13, 2008

(51) Int. Cl. B05B 1/30

(52) U.S. Cl. 239/579

(57) ABSTRACT

The present invention pertains to a water saving shower nozzle mainly having a main body with a cavity defined therein, and the cavity includes a fan-shaped cavity and a funnel-shaped cavity. Particularly, a plurality of jets are driven by a quasi-blade device inside the fan-shaped cavity, and the funnel-shaped cavity comprises an outlet disposed thereon. In this manner, the jets driven by the quasi-blade device assist in instantaneously conducting less water into the outlet so as to save water; furthermore, by means of the jets performing in a periodical rotation and the configuration of the funnel-shaped cavity, the water can finally be formed in dense water drops and sprayed out from the outlet in multiple directions, thereby achieving the strong water power same to the conventional incessant showering by reducing the water flow.

### BACKGROUND OF THE INVENTION

1. Field of the Invention

The present invention relates to bath equipments, particularly to a water saving shower nozzle.

2. Description of the Related Art

Typically, the shower equipment in the market commonly has a plurality of outlets disposed on the shower nozzle for incessantly outputting water, but the above design is accustomed to wasting too much water. For reducing the water flow, the American market hence requests the nozzle to add water-saving plates or decrease the numerals of the outlets to approach the goal, namely saving the water. Nevertheless, the increment of the water-saving-plate or the decrease of the outlets may reduce the water flow but oppositely relieve the outputting power of the water. Therefore, the above shower equipments are still unable to output strong water power by inputting less water, thus requiring improvements.

### SUMMARY OF THE INVENTION

The object of the present invention is to provide a water saving shower nozzle which facilitates to reduce the water flow and simultaneously achieves the outputting power of the water as the same as the convention incessant shower.

The water saving shower nozzle in accordance with the present invention mainly provides with a main body where a cavity is defined, and the cavity is divided by a fan-shaped cavity and a funnel-shaped cavity with an outlet formed on the bottom thereof. Particularly, the fan-shaped cavity has a quasi-blade device and a plurality of jets disposed under the quasi-blade device for being rotated thereby. By means of the above configuration, the quasi-blade device drives part of the jets to be in a high speed rotation so that the jets merely conduct less water into the funnel-shaped cavity, hence saving water; further, the funnel-shaped cavity assists in slantingly outputting water and accompanies the jets in a periodical rotation, the water thus is sprayed from the outlet in multiple directions and forms dense water drops, thereby achieving a strong shower power by reducing the water flow.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a cross-section view showing one preferred embodiment of the present invention;

FIG. 2 is a cross-section view showing the portion of A-A in FIG. 1; and

FIG. 3 is a cross-section view showing another preferred embodiment of the present invention.

FIG. 4 is a cross-section view showing the other preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

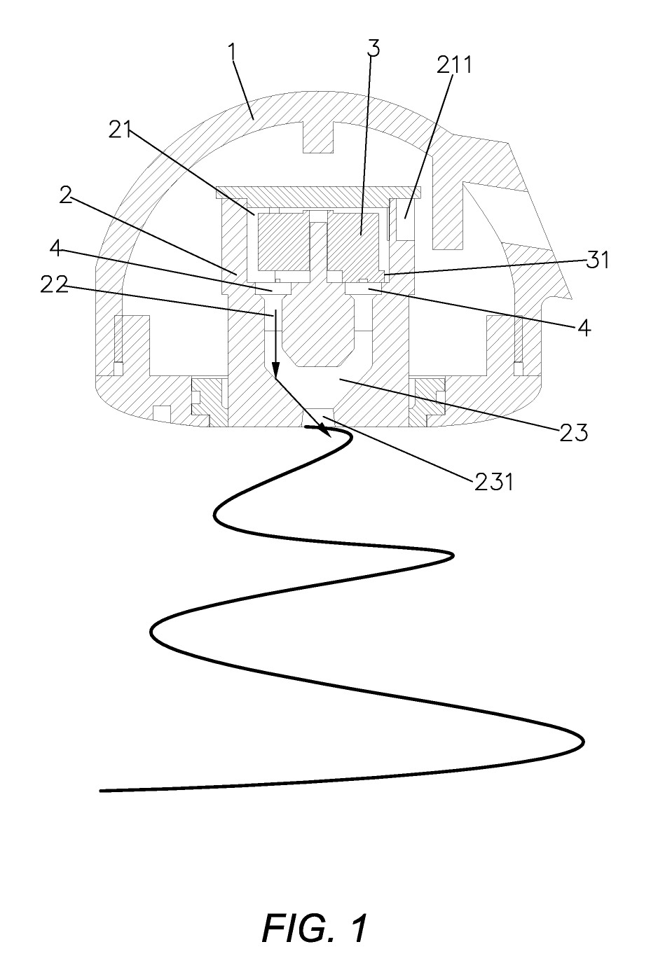

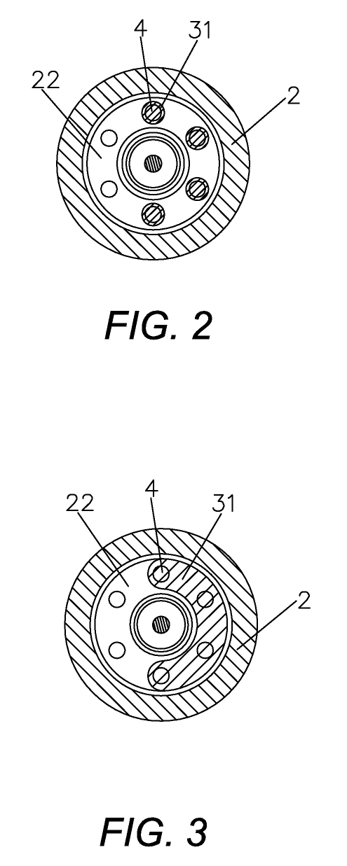

Referring to FIG. 1, one preferred embodiment of the present invention comprises a main body 1 and a cavity 2 defined therein, and the cavity 2 includes a fan-shaped cavity 21 formed on a top thereof, a funnel-shaped cavity 23 formed on a bottom thereof, and a ring-shaped cavity 22 disposed between the two cavities 21P 23; wherein, the fan-shaped cavity 21 has a quasi-blade device 3 located therein and an inlet 211 (for instance formed in a slope state) disposed by the side of the quasi-blade device 3. Further a plurality of ribs 31 are mounted under the quasi-blade device 3 and face the ring-shaped cavity 22 for operating with device 3; further, a plurality of jets 4 are disposed above the ring-shaped cavity 22, so that the ribs 31 block at least one jet 4(as illustrated in FIG. 2). Additionally, the funnel-shaped cavity 23 has an outlet 231 defined at its distal end for ultimately spraying the water out of the nozzle.

Referring to FIG. 1 and 2, while in operation, the water is initially conducted into the main body 1, and the water passes through the slope inlet 211 and thence hits the quasi-blade device 3 to generate a high speed rotation. In this manner, the ribs 31 on the quasi-blade device 3 periodically block part of the jets 4 (shown in FIG. 2), so that the unblocked jets 4 can instantaneously output less water into the ring-shaped cavity 22 for reducing the water flow, and simultaneously the jets 4 also perform in a periodical rotation. When the water subsequently goes through the ring-shaped cavity 22 and arrives in the funnel-shaped cavity 23, the water thence can be slantingly outputted from the outlet 231 (as arrowed in FIG. 1) to form dense water drops and finally be sprayed out of the body 1 in multiple directions, therefore the present invention not only saves the water but achieves the strong waterpower as the same as the common shower equipment which used to incessantly output water.

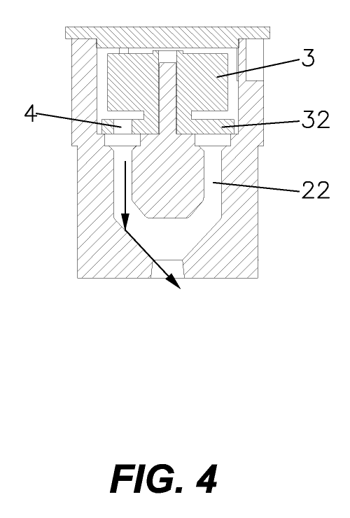

Referring to FIG. 3, another preferred embodiment of the present invention still comprises the similarly configurations and operations same to the previous embodiment. Differently, a fanned rib 31 is mounted on the quasi-blade device 3 and periodically blocks most of the jets 4 at once; furthermore, the quasi-blade device 3 can additionally have a rotary plate 32 (as shown in the FIG. 4) to be located thereunder for aiding in driving the jets 4, whereby the jets 4 are formed in a periodical rotation under the high speed driving of the device 3 and the fanned rib 31.

To sum up, the present invention takes advantages of the jets synchronically driven by the quasi-blade device 3 in the fan-shaped cavity 21 and only one outlet 231 disposed on the funnel-shaped cavity 23, whereby the jets 4 performing in a periodical rotation aid in conducting less water into the ring-shaped cavity 22 for saving the water. Furthermore, the configuration of the funnel-shaped cavity 23 facilitates to spray the water out of the outlet 231 in multiple directions, thereby still achieving the strong water power as the same as the conventional incessant showering.

While we have shown and described the embodiment in accordance with the present invention, it should be clear to those skilled in the art that further embodiments may be made without departing from the scope of the present invention.

I claim:

1. The water saving shower nozzle comprising a main body and a cavity defined inside said main body; wherein said cavity including a fan-shaped cavity formed on a top thereof and a funnel-shaped cavity formed on a bottom thereof; said fan-shaped cavity having a quasi-blade device located therein, an inlet disposed by the side of said quasi-blade device, and a plurality of jets disposed below said quasi-blade device and facing said funnel-shaped cavity for being rotated by said quasi-blade device; said funnel-shaped cavity having an outlet defined at a distal end thereof.

2. The water saving shower nozzle as claimed in claim 1, wherein, a ring-shaped cavity is disposed between said fan-shaped cavity and said funnel-shaped cavity, and said jets are mounted above said ring shaped cavity.

3. The water saving shower nozzle as claimed in claim 1, wherein, a plurality of ribs are disposed under said quasi-blade device for operating therewith and blocking one or more said jets.

4. The water saving shower nozzle as claimed in claim 1, wherein, a fanned rib is disposed under said quasi-blade device for operating therewith and blocking one or more said jets.

5. The water saving shower nozzle as claimed in claim 1, wherein, a rotary plate is located below said quasi-blade device and driven thereby, and said jets are disposed on said rotary plate.

6. The water saving shower nozzle as claimed in claim 2, wherein, a plurality of ribs are disposed under said quasi-blade device for operating therewith and blocking one or more said jets.

7. The water saving shower nozzle as claimed in claim 2, wherein, a fanned rib is are disposed under the quasi-blade device for operating therewith device and blocking one or more said jets.

8. The water saving shower nozzle as claimed in claim 2, wherein, a rotary plate is located below said quasi-blade device and driven thereby; said jets are disposed on said rotary plate.
